(19) United States
(12) Patent Application Publication
(10) Pub. No.: US 2006/0168004 A1
(43) Pub. Date: Jul. 27, 2006

(54) System and method for providing internet value-added service

(75) Inventors: Chang Suk Choe, Gyeonggi-do (KR); Chul Woo Kim, Seoul (KR); Jeong Tae Park, Seoul (KR); Jin Sik Park, Seoul (KR); Eun Young Han, Seoul (KR); Kwan Sang Na, Seoul (KR); Sun Jong Kwon, Seoul (KR); Jung Ho Park, Gyeonggi-do (KR)

Correspondence Address: MERCHANT & GOULD PC, P.O. BOX 2903, MINNEAPOLIS, MN, 55402-0903, US

(73) Assignee: KT Corporation, Gyeonggi-do (KR)

(21) Appl. No.: 10/536,332

(22) PCT Filed: Nov. 25, 2003
(86) PCT No.: PCT/KR03/02549

§ 371 Date: Nov. 4, 2005

(30) Foreign Application Priority Data
Nov. 25, 2002 (KR) 10-2002-0073640

(51) Int. Cl. G06F 15/16

(52) U.S. Cl. 709/206; 709/218

(57) ABSTRACT

The present invention generally relates to an Internet value-added service system and method for providing a conventional value-added service which has been provided in a web site with a message transmission medium of the Internet. More specifically, when an advertiser puts an advertisement through the message transmission medium of the Internet, the value-added service is also provided with the advertisement to improve advertising effects of the advertiser. Instead, SMS (short message service) is provided together in transmission of email to solve inconvenience of email reception, which results in replacement of email reception with the SMS.

### TECHNICAL FIELD

The present invention generally relates to a system and a method for providing internet value-added service, and more specifically, to a system and a method for providing internet value-added service which has been provided for service in web sites by using a message transfer medium of the Internet.

### BACKGROUND ART

In general, internet users receive various value-added services that give them entertainment or value and utility through various web sites. The value-added services include internet phone service, SMS (Short Messaging Service), MMS (Multimedia Messaging Service) for providing visual phone or visual mail, VOD (Video On Demand) service, AOD (Audio On Demand) service, and other internet contents such as cartoon and game.

These value-added services which are provided free or with fee are generally provided on membership basis according to service subscription. In case of free service, a service provider transmits advertisement to members, and the members can use service due to the advertisement. Accordingly, a user who wants to use value-added service should become a member of a web site for providing value-added service and visit a corresponding web site whenever the user wants to use the service.

A company or an advertiser that intends to advertise in the Internet generally advertise using internet portal sites for providing these value-added services or using a method for transmitting advertising emails with an email list.

However, advertisement on portal sites may be easily neglected by users, and it is difficult to obtain email lists of users. Moreover, random transmission of mass advertising emails is regarded as SPAM, and does not have a large effect on the advertisement.

In case of SMS of value-added services, a short message which is directly made in a mobile terminal or in a web site linked to a SMS server is generally transmitted. The SMS of the mobile terminal linked to various services is frequently used in information service. Of these value-added services, email service is typically used, and SMS notifies email arrival in email reception. This email arrival notification service is pay service which enables email receivers to confirm whether they receive emails with mobile terminals without frequently connecting to web sites for providing email service to confirm email reception. However, when email arrival notification service using this SMS is applied to all received emails, receivers may be inconvenient due to reception of excessive emails. In order to avoid receiving excessive emails, receivers should set email condition to receive arrival notification only on emails received from specific email addresses.

### DETAILED DESCRIPTION OF THE INVENTION

Accordingly, it is an object of the present invention to provide value-added service using a message transfer medium of the Internet in order to relieve inconvenience of internet users who should visit a corresponding web site whenever they intends to use value-added service.

It is another object of the present invention to provide value-added service with advertisement using a message transfer medium of the Internet in order to improve advertising effect of an advertiser using the Internet.

It is still another object of the present invention to substitute email reception with SMS by providing SMS in transmission of emails in order to solve inconvenience of email reception.

In an embodiment, a system for providing internet value-added service comprises: a first message transfer server for providing service to transmit a message transfer medium in Internet, for providing a value-added service usage ticket attached to the message transfer medium to a value-added service provider, for administering information of the service provider and the value-added service usage ticket, and for transmitting the message transfer medium accompanying with the value-added service usage ticket if the service provider transmits the value-added service usage ticket attached to the message transfer medium; a second message transfer server for receiving the message transfer medium accompanying with the value-added service usage ticket which the service provider transmits to an internet user who logs in with a user terminal; and a value-added service server for providing value-added service in the Internet, and for providing the value-added service to the user terminal by using the information of the service provider and the value-added service usage ticket transmitted from the first message transfer server if usage of the value-added service usage ticket is required from the internet user.

In an embodiment, a method for providing internet value-added service comprises: a first process for setting the value-added service usage ticket information in an internet message transfer server if an internet value-added service provider purchases a value-added service usage ticket on value-added service to be provided; a second process for providing information of the set value-added service usage ticket to a value-added service server for providing the value-added service in the internet message transfer server; a third process for transmitting the set value-added service usage ticket attached to a message transfer medium in the internet message transfer server if the value-added service provider requires transmission of a message transfer medium accompanying with the value-added service usage ticket; and a fourth process for providing the value-added service in the value-added service server contracted on the value-added service usage ticket with the internet message transfer server if an internet user receiving the message transfer medium accompanying with the value-added service usage ticket requires usage of the value-added service usage ticket.

### BRIEF DESCRIPTION OF THE DRAWINGS

FIG. 1 is a diagram illustrating a system for providing internet value-added service according to an embodiment of the present invention.

FIG. 2 is an exemplary diagram illustrating a screen provided to set a value-added service usage ticket according to an embodiment of the present invention.

FIG. 3 is an exemplary diagram illustrating a value-added service usage ticket provided with an internet message transfer medium according to an embodiment of the present invention.

FIG. 4 is a flow chart illustrating a method for providing internet value-added service according to an embodiment of the present invention.

FIG. 5 is a diagram illustrating an internet multi-step advertising system according to a first embodiment of the present invention.

FIG. 6 is an exemplary diagram illustrating a screen provided for an advertiser to set transmission of advertising emails according to a first embodiment of the present invention.

FIG. 7 is an exemplary diagram illustrating an advertising email that is transmitted to an internet user accompanying with a value-added service gift certificate according to a first embodiment of the present invention.

FIG. 8 is a flow chart illustrating an internet multi-step advertising method according to a first embodiment of the present invention.

FIG. 9 is a diagram illustrating an email service system according to a second embodiment of the present invention.

FIG. 10 is an exemplary diagram illustrating a screen provided for an email sender to write email, purchase a SMS gift certificate and designate various options thereof according to a second embodiment of the present invention.

FIG. 11 is an exemplary diagram illustrating an email received by an email receiver according to a second embodiment of the present invention.

FIG. 12 is a flow chart illustrating a method for providing email service according to a second embodiment of the present invention.

### PREFERRED EMBODIMENTS

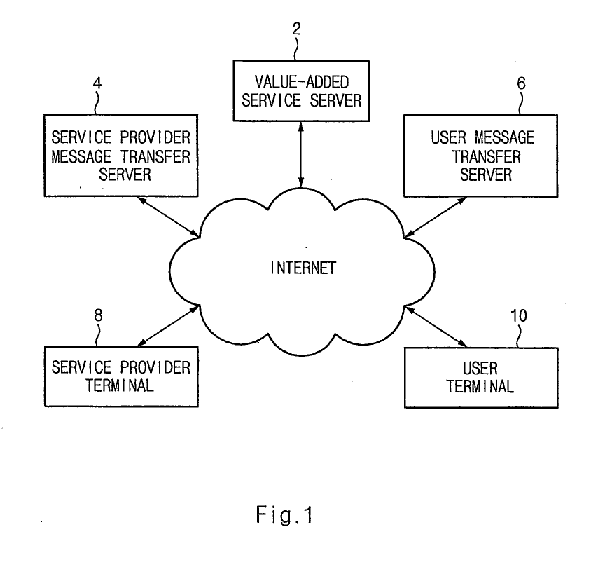

FIG. 1 is a diagram illustrating a system for providing internet value-added service according to an embodiment of the present invention.

A service provider who provides value-added service connects to a service provider message transfer server 4 through a service provider terminal 8, and provides value-added service to a user by using a message transfer medium provided in the service provider message transfer server 4.

The service provider message transfer server 4 interworking with a value-added service server 2 transmits information on usage of value-added service (hereinafter, referred to as ‘value-added service usage ticket’) attached to the message transfer medium into a user message transfer server 6. The message transfer medium includes all media which basically adopt a HTML (Hypertext Markup Language) format such as an email, a multi-media message and an instant messenger type note. The service provider message transfer server 4 and the user message transfer server 6 as servers for transmitting same kinds of message transfer media may be an email service server, a MMS server and an instant messenger server.

The value-added service server 2 interworking with the service provider message transfer server 4 receives basic information on the value-added service usage ticket that the service provider message transfer server 4 transmits to a user from the service provider message transfer server 4, and administrates the information. The value-added service server 2 also provides value-added service to a user with reference to information on the value-added service usage ticket administered when the user uses the value-added service usage ticket, and charges for the provided value-added service to the service provider.

The user connects to the user message transfer server 6 through a user terminal 10, and receives value-added service which the service provider provides using a value-added service usage ticket included in a message transfer medium.

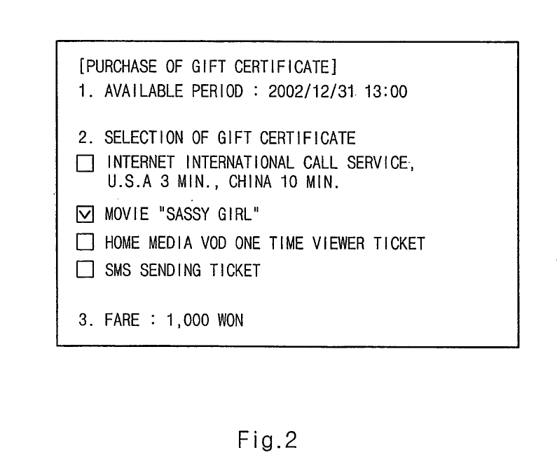

FIG. 2 is an exemplary diagram illustrating a screen provided to the service provider terminal 8 from the service provider message transfer server 4. Through the screen, a service provider who connects to the service provider message transfer server 4 can set a value-added service usage ticket to be included in a message transfer medium.

As shown in FIG. 2, a screen for setting a value-added service gift certificate includes items on a section for setting an available period of a corresponding service gift certificate, a section for selecting value-added service to be provided to a user and a section for displaying a fee of the corresponding service gift certificate. By selecting one of the above items, the service provider allows a user to use value-added service with a corresponding service gift certificate, and selects value-added service to be provided to a user. As a result, a fee of the corresponding service gift certificate that the service provider should pay.

The value-added service that a user can use with the gift certificate free of charge includes internet phone, movie viewer, VOD service, AOD service, SMS, game and internet cartoon, which may be changed by service provided in the value-added service server 2.

The service provider message transfer server 4 administrates corresponding information on the service gift certificate included in the message transfer medium that the service provider transmits, as shown in Table 1.

TABLE 1

| | Service | Available | Kinds of | Fee | |
|---|---|---|---|---|---|
| Key | provider | period | service | (won) | Others |
| F11AD . . . | A Co. | 2002/12/31 | Movie viewer | 1,000 | . |
| | | | | | . |
| | | | | | . |
| FA1AD . . . | Tom | 2003/01/01 | Internet phone | 300 | . |
| | | | | | . |
| | | | | | . |
| . | . | . | . | . | . |
| . | . | . | . | . | . |
| . | . | . | . | . | . |

In Table 1, the key is an encoded key of unilateral code generated in the service provider message transfer server 4 in every gift certificate for security of the service gift certificate. The user who receives the service gift certificate only uses value-added service. The service provider is a person who transmits the service gift certificate attached to the message transfer medium. The available period is a usage limit of the service gift certificate that the service provider sets. The kinds of service represent kinds of value-added service provided by a corresponding service gift service certificate. The fee represents a price of the corresponding service gift certificate, which is to be charged to the service provider.

Table 1 corresponds to information on the value-added service usage ticket transmitted from the service provider message transfer server 4 to the value-added service server 2 as described above.

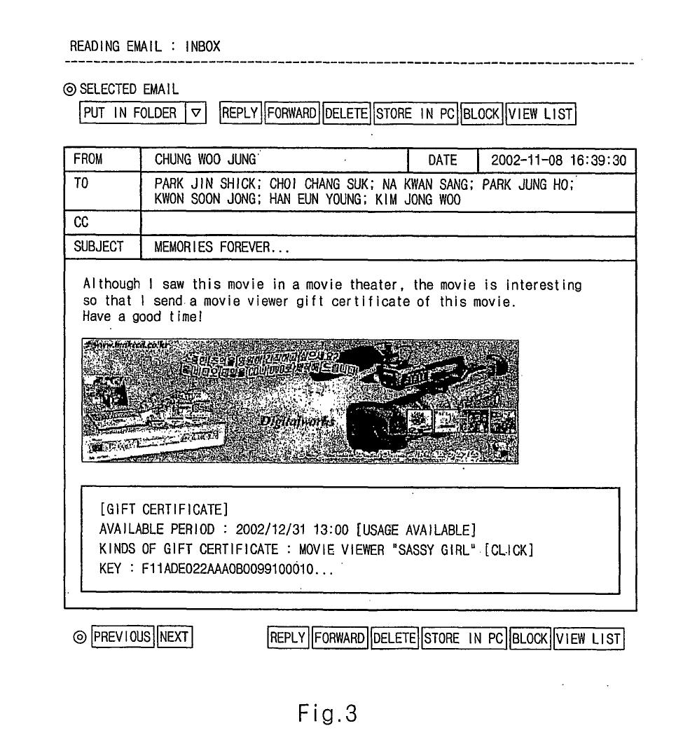

FIG. 3 is an exemplary diagram illustrating a value-added service usage ticket provided with an internet message transfer medium received to the usage message transfer server 6. In this example, a message transfer medium is an email, and value-added service is movie viewing.

As shown in FIG. 3, an available period set by the service provider and kinds of value-added service are displayed in the received value-added service usage ticket (shown as a gift certificate in FIG. 3). An encoding key generated in the service provider message transfer server 4 is also displayed in FIG. 3. If a user clicks a ‘movie viewer [Click]’ button to use the gift certificate, the value-added service that has been reserved in the value-added service server 2 by the service provider message transfer server 4.

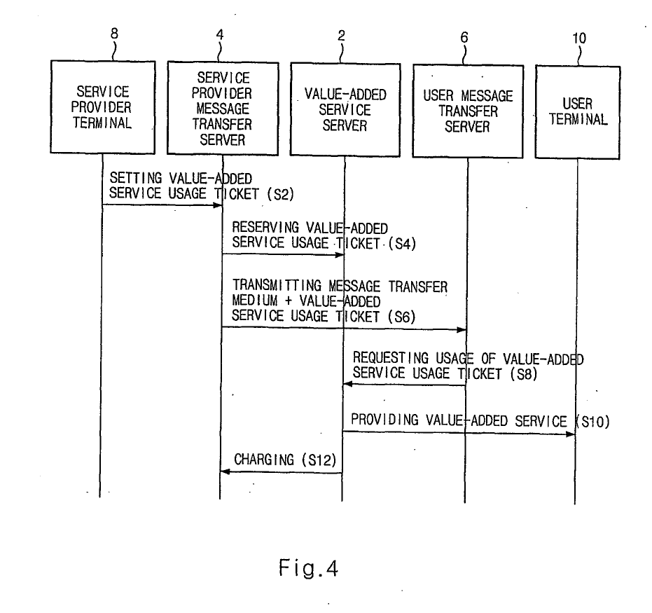

FIG. 4 is a flow chart illustrating a method for providing internet value-added service according to an embodiment of the present invention.

First, a service provider connects to the service provider message transfer server 4 using the service provider terminal 8, and sets a value-added service usage ticket on value-added service to be provided to a user as shown in FIG. 2 (S2).

Then, if the service provider transmits the value-added service usage ticket attached to a message transfer medium to a user, the service provider message transfer server 4 transmits information (for example, Table 1) on the value-added service usage ticket set by the service provider to the value-added service server 2 to reserve the value-added service (S4), and then transmits the message transfer medium accompanying with the value-added service usage ticket to the user message transfer server 6 (S6).

Thereafter, if the user connects to the user message transfer server 6 using the user terminal 10 and requests usage of the value-added service usage ticket attached to the message transfer medium received as shown in FIG. 3 (S8), the value-added service server 2 determines the reserved value-added service with reference to a corresponding encoding key and directly provides the service to the user terminal 10 (S10).

The value-added service server 2 charges for the usage ticket that does not provide the value-added service any more to the service provider through the service provider message transfer server 4 (S12). Table 2 shows an example of a charge data table administrated by the value-added service server 2.

TABLE 2

| | | User IP | | | |
|---|---|---|---|---|---|
| Order | Key | address | Date | Charge details | Other |
| . | . | . | . | . | . |
| . | . | . | . | . | . |
| . | . | . | . | . | . |
| 52 | F11AD . . . | x.x.x.x | 2002/11/12 13:01 | xxx xxx xxx | . |
| | | | | | . |
| | | | | | . |
| . | . | . | . | . | . |
| . | . | . | . | . | . |
| . | . | . | . | . | . |

As shown in FIG. 2, in charge data, values of encoding keys of the service provider are included, and an IP (Internet Protocol) address, date and charge details of the user are recorded. The charge details mean record of detail bases such as position and usage time of service corresponding to sending and receiving sites in case of communication service and IP addresses in case of content providing service such as multi-media broadcasting or game.

As described above, it is important that the user message transfer server 6 does not interwork with the value-added service server 2 although a value-added service usage ticket is used by a user, in the system and method for providing value-added service using an internet message transfer medium according to an embodiment of the present invention.

In more details, the value-added service usage ticket is generated from the service provider message transfer server 4 according to information set by the service provider, and transmitted with the message transfer medium into the user message transfer server 6. The user message transfer server 6 only displays to the user a source of the value-added service usage ticket included in the received message transfer medium, and does not interwork with the value-added service server 2 for screen display of the value-added service usage ticket or for use of the value-added service usage ticket.

When the service provider message transfer server 4 generates the value-added service usage ticket, if the user clicks a usage menu (for example, the ‘movie viewer [Click]’ button in FIG. 3) of the value-added service usage ticket, the usage menu and the linked value-added service server 2 controls base particulars so that the value-added service usage ticket may be used.

In the embodiment according to the present invention, interworking between the user message transfer server 6 and the value-added service server 2 on the user who uses the value-added service is not performed, but interworking between the service provider message transfer server 4 and the value-added service server 2 on the service provider who provides the value-added service. If the message transfer medium is the same between the service provider and the user, the service provider provides the value-added service to any user.

The service provider message transfer server 4 may be the same server as the value-added service server 2, and the user message transfer server 6 may be the same server as the service provider message transfer server 4 or the value-added service server 2 because the value-added service and the message transfer service using the Internet is one of services provided simultaneously from one internet business site.

When the service provider is business for providing value-added service commercially, the business receives user registration in the value added service server 2 operated by the business and transmits a value-added service usage ticket attached to a message transfer medium through a message transfer server contracted with the value-added service server 2 using user information. Therefore, the business enables the user to use the value-added service without directly connecting to the value-added service server 2 so that the business can provide more convenient service to the user. If the service provider is a common internet individual user, the internet individual user purchases a value-added service usage ticket using a message transfer server contracted with the value-added service server 2 to provide the usage ticket to other user.

Hereinafter, preferred embodiments of the present invention will be described in detail.

The first embodiment of the present invention is an internet multi-step advertising system and method. In the first embodiment, an advertiser provides a value-added service usage ticket as a price of permission of advertisement to an internet user in order to put advertisements to numerous internet users. Additionally, in the first embodiment, the transmission of advertisement from the advertiser to the internet user is not limited once. Rather, the value-added service usage ticket transmitted to the initial internet user can be continuously used even though it is transmitted to other internet users at multi steps so that the advertisement transmitted with the value-added service usage ticket is automatically transmitted among internet users.

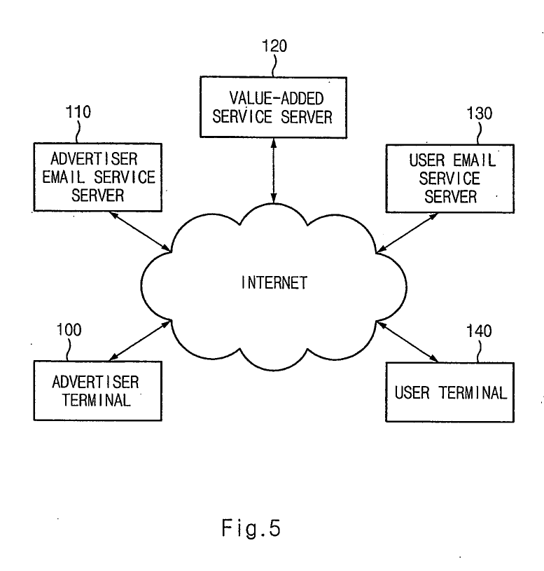

FIG. 5 is a diagram illustrating an internet multi-step advertising system according to a first embodiment of the present invention. The message transfer medium is an email in the first embodiment.

An advertiser who intends to advertise connects to an advertiser email service server 110 using an advertiser terminal 100.

The advertiser email service server 110 provides service so that the advertiser may put the internet multi-step advertisement. The advertiser sends the advertising email to an internet user who permits reception of the advertising emails by using the advertiser email service server 110.

To the advertising emails for the internet multi-step advertisement is attached the value-added service usage ticket which can be used free of charge as a price of the reception of the advertising emails, and the usage ticket is transmitted to acquaintances by the user. As a result, since the advertising contents are transmitted together, the internet user does not regard the advertisement as a spam to delete the email but the email is continuously transmitted from one to another.

When the value-added service usage ticket attached to the advertising email being used, a value-added service server 120 provides value-added service, administrates the value-added the service usage ticket by interworking with the advertiser email service server 110 for providing the internet multi-step advertising service to the advertiser, and charges for a future usage of the usage ticket.

A user email service server 130 receives advertising emails sent by the advertiser from the advertiser email service server 110, and provides the advertising emails to an internet user. The internet user connects to the user email service server 130 by using a user terminal 140 to receive advertising emails, and uses value-added service by using the value-added service usage ticket attached to the advertising email.

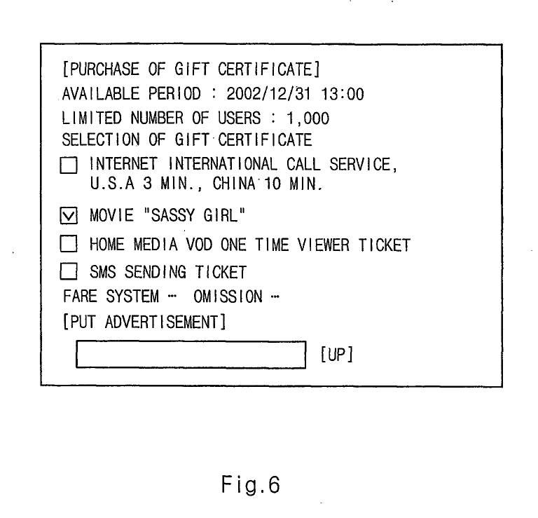

FIG. 6 is an exemplary diagram illustrating a screen provided from the advertiser email service server 110 to the advertiser terminal 100 so that the advertiser who connects to the advertiser email service server 110 can set transmission of advertising emails.

The advertiser purchases a value-added service usage ticket (hereinafter, referred to as ‘gift certificate’) attached with the advertisement, and sets the usage ticket.

As shown in FIG. 6, on the setting screen of the value-added service gift certificate are displayed an available period when the internet user who receives the advertising email can use a gift certificate, the user limited number where the number of users who can use the gift certificate is limited, a portion where the user can select kinds of value-added service provided in the gift certificate and an input box where advertisement can be put.

The advertiser enables an internet user who receives the advertising email to use the value-added service for a predetermined period. The usage of the value-added service gift certificate is limited through the user limited number so that the advertisement may be transmitted to a predetermined number of people.

The kinds of value-added service provided in the gift certificate can be selected in the check box, and the advertisement can be directly inputted in the input box whereupon the advertisement is put and the previously prepared content of the advertisement can be attached herein.

The value-added service that internet users can use through the above-described gift certificate free of charge include internet phone service, movie viewer service, VOD service; AOD service, SMS, game and internet cartoon, which can be changed according to service provided from the value-added service server 120.

The advertiser email service server 110 administrates data wherein the advertiser sets the advertising email and the gift certificate to be attached to the advertising email, as shown in Table 3.

TABLE 3

| | | | Number of advertisement | |
|---|---|---|---|---|
| | Contract | Available | distribution | |
| Key | advertiser | period | targeted users | other |
| F11AD . . . | A Co. | 2002/12/31 | 100 | . |
| | | | | . |
| | | | | . |
| FA1AD . . . | B Inc. | 2003/01/01 | 200 | . |
| | | | | . |
| | | | | . |
| . | . | . | . | . |
| . | . | . | . | . |
| . | . | . | . | . |

In Table 3, the key is an encoded key of a unilateral code generated from the advertiser email service server 110 in each gift certificate for security of the value-added service gift certificate. Through this key, only a person who receives the gift certificate can use the value-added service using the gift certificate.

The contract advertiser represents an advertiser who sends advertising emails accompanying with value-added service gift certificate contracted with the advertiser email service server 110. The available period represents that the advertiser sets the available period of the value-added service gift certificate in FIG. 6, and the number of advertisement distribution represents that the advertiser sets the user limited number in FIG. 6.

As shown in FIG. 3, information on the value-added service gift certificate that attached to the advertising email administrated in the advertiser email service server 110 is provided to the value-added service server 120 so that the value-added service server 120 may administrate the gift certificate.

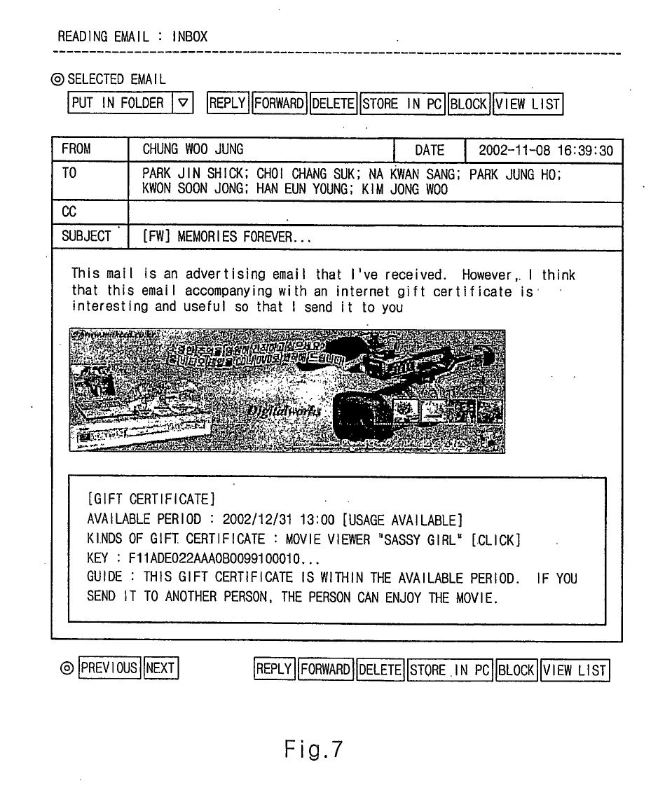

FIG. 7 is an exemplary diagram illustrating an advertising email that is transmitted to an internet user accompanying with a value-added service gift certificate. In a header of the advertising email, a sender transmits an email accompanying with the value-added service gift certificate to several acquaintances. To the email is attached the gift certificate by which a user can watch a movie with an advertisement having the content where a home video tape is produced as a CD (Compact Disk) or DVD (Digital Versatile Disk). That is, internet users receive a free gift certificate with which a user can watch a movie while receiving an advertisement.

In this gift certificate, the available period for which a user can use the gift certificate is displayed. If the user clicks the ‘movie viewer [Click]’ button in the gift certificate within the available period, the user can watch the movie in free of charge. Also, the gift certificate includes the key generated from the advertiser email service server 110 in transmission of the gift certificate. In contract of the gift certificate, the key is transmitted from the advertiser email service server 110, and compared with a key administrated in the value-added service server 120, thereby preventing a forgery and an alteration of gift certificates.

Internet users who receive the value-added service gift certificate with advertisement from acquaintances enables other acquaintances to watch a movie by transmitting advertising emails to the other acquaintances. As a result, advertisement that an advertiser wants may be distributed actively among internet users, thereby obtaining advertising effects.

When an internet user uses the value-added service gift certificate, the value-added service server 120 provides the resulting value-added service.

Table 4 shows an administration table of information administrated in the value-added service server 120 until a value-added service gift certificate is generated by an advertiser and used by an internet user.

TABLE 4

| | | | Number of advertisement | | |
|---|---|---|---|---|---|
| | Contract | Available | distribution targeted | Number of | |
| Key | Advertiser | period | users | service users | other |
| F11AD . . . | A Co. | 2002/12/31 | 100 | 100 | . |
| | | | | | . |
| | | | | | . |
| FA1AD . . . | B Inc. | 2003/01/01 | 200 | 60 | . |
| | | | | | . |
| | | | | | . |
| . | . | . | . | . | . |
| . | . | . | . | . | . |
| . | . | . | . | . | . |

As shown in Table 3, the key of Table 4 is an encoded key generated from the advertiser email service server 110 for security of gift certificates. The value-added service server 120 determines that an internet user who intends to receive a value-added service using the key receives the value-added service using a gift certificate that the advertiser provides.

The contract advertiser, the available period and the number of advertisement distribution targeted users are set by the advertiser and provided from the advertiser email service server 110. The number of service users is the number where internet users receiving advertising emails accompanying with a value-added service gift certificate use the gift certificate.

The value-added service server 120 checks the number of usage of the gift certificate by using information of the gift certificate provided from the advertiser email service server 110, and provides the value-added service corresponding to the gift certificate as many as the number of advertisement distribution targeted users set by the advertiser.

Referring to FIG. 7, a message [usage available] is displayed in the available period.

The message which is linked in the value-added service server 120 is displayed as [usage available] only when the number of service users is smaller than that of advertisement distribution targeted users and as [usage impossible] after gift certificates are all used even within the available period.

If the message [usage impossible] is displayed, the internet users cannot receive the value-added service any more. As a result, the internet users do not send the advertising emails to acquaintances and the advertisement is no more transmitted.

Table 5 as a charge data table administrated by the value-added service server 120 for the gift certificated set by the advertiser shows the charge data of the contract advertiser of A Co. in Table 4.

TABLE 5

| | | User IP | | | |
|---|---|---|---|---|---|
| No. | Key | address | Date | Charge details | Other |
| . | . | . | . | . | . |
| . | . | . | . | . | . |
| . | . | . | . | . | . |
| 52 | F11AD . . . | x.x.x.x | 2002/11/12 13:01 | xxx xxx xxx | . |
| | | | | | . |
| | | | | | . |
| 53 | . | x.x.x.x | 2002/11/12 14:01 | xxx xxx xxx | . |
| | . | | | | . |
| | . | | | | . |
| 54 | . | x.x.x.x | 2002/11/13 16:20 | xxx xxx xxx | . |
| | . | | | | . |
| | . | | | | . |
| 55 | . | x.x.x.x | . | . | . |
| | . | | . | . | . |
| | . | | . | . | . |

As shown in Table 5, the number of users who use the gift certificate of the advertiser A Co. is 55, and charge data thereof is represented.

The charge data includes a value of the gift certificate key of the advertiser A Co., the IP (internet protocol) address and the data of an internet user who uses the gift certificate and the charge details. Although the advertiser A Co. makes a contract on the number of advertisement distribution targeted users to be 100, if only 55 people used the gift certificate within the available period, the advertiser can settle accounts only on the 55 cases.

In transmission of the advertising emails using the value-added service gift certificate to provide the value-added service, the value-added service server 120 is interworked while the value-added service gift certificate is used by an internet user. Here, it is important that the above interworking does not mean interworking between the user email service server 130 to which the internet user connects and the value-added service server 120.

In more details, the value-added service gift certificate is generated by the advertiser email service server 110 to which the advertiser connects according to information set by the advertiser. If the gift certificate is transmitted with the advertising content from the advertiser email service server 110 to the user emails service server 130, the user email service server 130 only displays a source of the received advertising email on the body of the email in FIG. 7 but does not interwork with the value-added service server 120 for screen display of the value-added service gift certificate or for usage of the value-added service gift certificate.

The advertiser email service server 110 generates gift certificates as a type of value-added service gift certificate of FIG. 7 according to information set by the advertiser. If an internet user clicks the ‘movie viewer [Click] button’ of the value-added service gift certificate, the advertiser email service server 110 interworking with the value-added service server 120 links the ‘movie viewer [Click]’ button with the value-added service server 120 so that the value-added service may be transmitted. Thus, the advertiser email service server 110 administrates all value-added service gift certificates so that the value-added service gift certificates may be used regardless of the user email service server 130 which receives advertising emails.

Therefore, an internet user who receives advertising emails has no relation with advertising email transmission service using value-added service gift certificates provided by the advertising emails service server 110. If only the internet user who first receives advertising emails makes a contract with an advertiser to receive an advertising email.

Here, the advertiser email service server 110 may be the same server as the value-added service server 120 and the user email service server 130 may be the same server as the advertiser email service server 110 or the value-added service server 120 because value-added service and email service are services provided simultaneously from one internet business site.

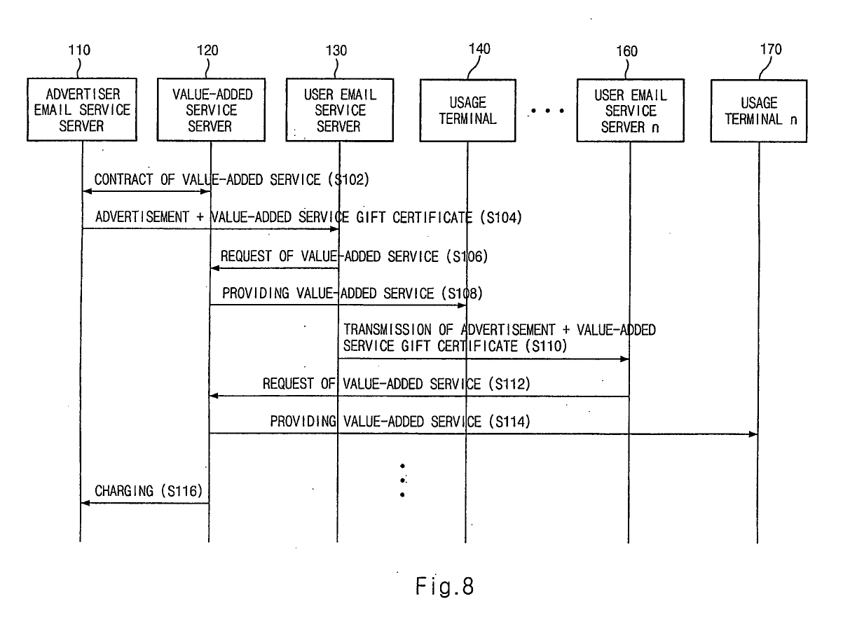

FIG. 8 is a flow chart illustrating an internet multi-step advertising method using the value-added service gift certificate by configuration of FIG. 5 according to the first embodiment of the present invention.

An advertiser connects to the advertiser email service server 110 using the advertiser terminal 100, and makes an contract on an advertisement and a value-added service with interworking with the value-added service server 120 as shown in FIG. 6 (S102).

If an advertising email accompanying with a value-added service gift certificate is sent from the advertiser email service server 110, the advertising email is transmitted into the user email service server 130 of an internet user who permits a reception of the advertising email (S104).

The internet user connects to the user email service server 130 using the user terminal 140, and requests usage of the value-added service usage right attached to the advertising email that the internet user receives as shown in FIG. 7 (S106). Then, the value-added service server 120 determines the value-added service reserved with the reference to a corresponding encoding key, and directly provides the service to the user terminal 140 (S108).

If the internet user who receives the advertising email accompanying with the value-added service gift certificate sends the received email accompanying the value-added service gift certificate to an acquaintance, the user email service server 130 transmits the advertising email accompanying with the value-added service gift certificate to a user email service server n 160 of the acquaintance (S110). The acquaintance confirms the advertising email received from the user email service server 130 through the user email service server n 160, and requests usage of the value-added service usage right attached to the received advertising email (S112). Then, the value-added service server 120 determines the value-added service reserved with reference to a corresponding encoding key, and directly provides the service to the user terminal n 170 of an acquaintance (S114).

These value-added service usage steps (S106, S108, S112, S114) and the transmission step of the advertising email to the acquaintance (S110) may be changed depending on internet users, and the advertising email accompanying with the value-added service gift certificate is transmitted from one to another.

After the advertisement is transmitted from one to another and the resulting value-added service is provided, the value-added service server 120 charges for usage of the gift certificate after the available period to the advertiser through the advertiser email service server 110.

Although the internet multi-step advertisement using emails is explained in the above first embodiment, the first embodiment is not limited in emails but may be applied to MMS, instant messenger type notes as well as emails because emails, MMS and instant messenger type notes basically have a HTML type. As a result, all types of message that transfer media using the Internet can be used by linking the gift certificate to the value-added service server with the HTML type to emails or notes.

In a second embodiment of the present invention which is an email service system and a method using the same, a value-added service gift certificate limited in SMS of value-added service usage rights is provided together in transmission of emails so that a user may receive a short message as a reply to an email.

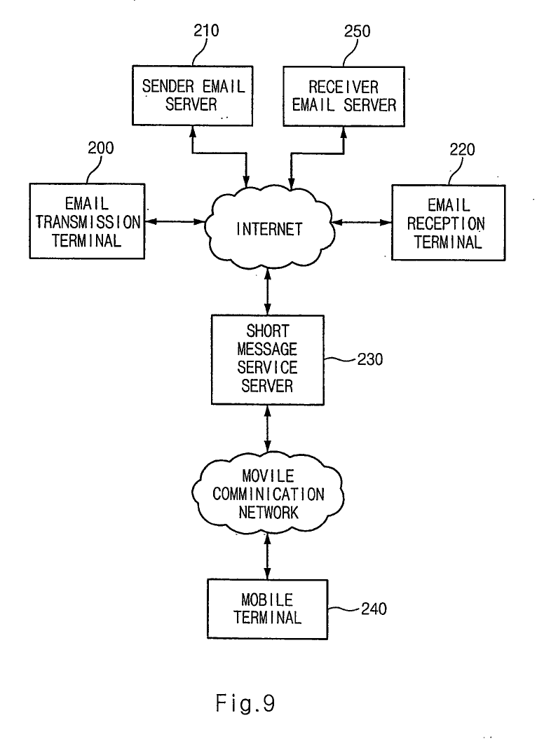

FIG. 9 is a diagram illustrating an email service system according to a second embodiment of the present invention.

A sender email server 210 provides emails service using a SMS gift certificate to a user.

An email transmission terminal 200 provides a user interface so that an email sender who connects to the sender email server 110 may purchase a SMS gift certificate and transmit the SMS gift certificate attached to the prepared email.

A reception email server 250 as a serve for basically providing emails service receives an email accompanying with a SMS gift certificate and provides the email to a user.

An email reception terminal 220 provides a user interface so that an email receiver who connects to a receiver email server 150 may receive the email transmitted from the sender email server 110 and prepare a short message using the attached SMS gift certificate to transmit the short message.

A short message service server 230 provides a short message service for providing the short message prepared in the email reception terminal 220 to a mobile terminal 240.

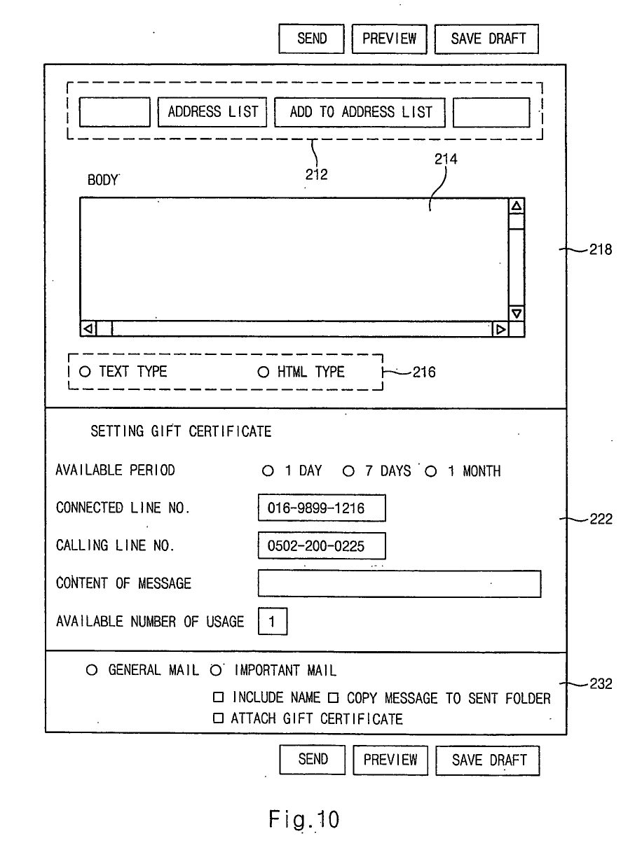

If an email sender connects to the sender email server 210 using the email transmission terminal 200, the sender email server 210 provides a screen shown in FIG. 10 to the email sender.

FIG. 10 is an exemplary diagram illustrating a screen provided for an email sender to write an email, purchase a SMS gift certificate and designate various options thereof. The screen comprises an email writing portion 218, a SMS gift certificate setting portion 222 and an email setting portion 232.

The email writing portion 218 comprises an address input box 212 where an address of an email receiver is inputted, a body input box 214 where the content of the email is written and an email type check box 216 where email types such as a general text type or a HTML type are selected.

A SMS gift certificate setting portion 222 comprises a check box and an input box where various settings can be made to the SMS gift certificate to be attached to an email. Here, a user can set an available period of the gift certificate, a connected line number of the mobile terminal 240 that receives the short message, a calling line number of the sender who sends the short message, the content of the short message and the available number of usage of the gift certificate.

After completion in writing of emails and in setting of the SMS gift certificate, the email sender clicks a mail sending menu by selectively checking importance of the email (general letter, express letter, etc.), name inclusion, storage in sent letter box, attachment of the gift certificate of the email setting portion 232. As a result, the email accompanying with the SMS gift certificate is transmitted.

The interface screen of the SMS gift certificate setting portion 222 provided by the sender email server 210 is not a screen provided by the sender email server 210 interworking with the short message service server 230 but an interface used to receive selection items of the SMS gift certificate in the sender email server 210. That is, when the email sender purchases a SMS gift certificate, the sender email server 210 does not interwork with the short message service server 230.

Thereafter, if the email accompanying with the SMS gift certificate is transmitted to the sender email server 210 by the email sender, the sender email server 20 generates keys and an administration table using information of the email sender and the gift certificated set by the email sender for administration of the purchased gift certificate, as shown in FIG. 6.

TABLE 6

| | | | | Calling | | | | |
|---|---|---|---|---|---|---|---|---|
| | | Available | Connected | line | Content | Available | | |
| Key | User ID | period | line number | number | of SMS | number | Importance | Other |
| F11AD . . . | Cwkim | 1 | 016 . . . | Open | xxxxxx | 1 | Middle | . |
| | | | | | | | | . |
| | | | | | | | | . |
| FA1AD . . . | Cwkim | 7 | Open | Open | Open | 2 | High | . |
| | | | | | | | | . |
| | | | | | | | | . |
| . | . | . | . | . | . | . | . | . |
| . | . | . | . | . | . | . | . | . |
| . | . | . | . | . | . | . | . | . |

In Table 6, the key is an encoded key of a unilateral code generated from the sender email server 210 in each gift certificate for security of the SMS gift certificate. Only a person who receives the gift certificate through this key is enabled to transmit a short message using the gift certificate.

The sender email server 210 generates a key by combining an encoded key with an email address of a final user of the SMS gift certificate. As a result, mis-use of the key can be prevented, and a forgery and an alteration can be checked.

A user ID is an ID of a user who subscribes to an email service using the SMS gift certificate provided by the sender email server 210, and an ID of a subscriber who sends an email.

The available period, the connected line number, the calling line number, the content of SMS, the available number and importance are the contents inputted by the email sender in the SMS gift certificate setting portion 222 and the email setting portion 232 of FIG. 10. The ‘Open’ means a setting condition where the email receiver can use at random because the email sender does not input the contents.

Information of the administration table of the sender email server 210 generated from the sender email server 210 is transmitted to the short message service server 230. When the email receiver uses the gift certificate, the short message service server 230 provides short message service by using information of the gift certificate.

Table 7 is an administration table of the short message service server 230.

TABLE 7

| | | | Connected | Calling | | | | | |
|---|---|---|---|---|---|---|---|---|---|
| | User | Available | line | line | Content | Available | | Used | |
| Key | ID | period | number | number | of SMS | number | Importance | number | state |
| F11AD . . . | Cwki [symbol] | 1 | 016 . . . | Open | xxxxxx | 1 | Middle | 0 | Unused |
| FA1AD . . . | Cwki [symbol] | 7 | Open | Open | Open | 2 | High | 0 | Unused |
| . | . | . | . | . | . | . | . | . | . |
| . | . | . | . | . | . | . | . | . | . |
| . | . | . | . | . | . | . | . | . | . |

As shown in Table 3, the short message service server 230 administrates the number of usage of the gift certificate used by the email receiver as well as information of the SMS gift certificate received from the sender email server 210 so that the gift certificate may be used according to setting of the email sender.

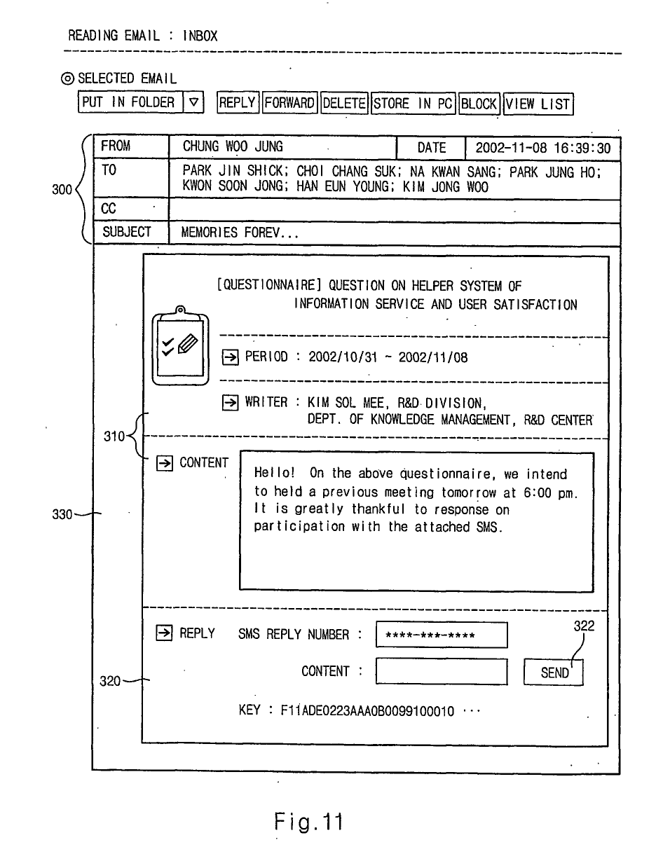

FIG. 11 shows an example of the email that the email receiver receives.

The email receiver that the email receiver receives comprises an email information portion 300 including information on a sender, date and title and a body portion 330.

In the body portion 330 are displayed the content 310 of the body that the email sender writes in the body input box 214 of FIG. 10 and the SMS gift certificate 320 including information set in the SMS gift certificate setting portion 222 of FIG. 10.

As the email sender sets, the SMS gift certificate 320 includes an input box of a reply number (FIG. 11 shows a case where a connected line number that the email sender sets is inputted) to which a short message is connected, a message input box where the content of a short message is inputted, and a key value of the gift certificate generated by the sender email server 210. The pattern of the gift certificate may be changed depending on setting of the email sender.

If the email receiver transmits a short message using the SMS gift certificate 320, the short message service server 230 determines availability of the gift certificate with reference to the administration table of FIG. 7 and transmits the short message as a reply number.

Here, the short message service server 230 is interworked if the SMS gift certificate 320 is used by the email receiver. This interworking does not mean the interworking between the receiver email server 250 to which the email receiver connects and the short message service server 230.

In more detail, the SMS gift certificate 320 is generated by the sender email server 210 depending on information set by the email sender. Then, the sender email server 210 transmits the gift certificate with the content of the body in the email to the receiver email server 250, the receiver email server 250 only displays a source of the received email in the body portion 330 of FIG. 11, and does not interwork with the short message service server 130 for screen display of the gift certificate 320 or usage of the gift certificate 320.

The sender email server 210 generates a gift certificate as a type of the SMS gift certificate 320 of FIG. 11 depending on information set by the mail sender. When the gift certificate is generated, if the email receiver clicks a transmission button 322 of the SMS gift certificate 320, the sender email server 210 interworks with the short message service server 230 and links the transmission button 322 with the short message service server 230 so that the short message may be transmitted. As a result, the sender email server 210 administrates all about the SMS gift certificate 320 so that it may be used regardless of the receiver email server 250.

Therefore, the email receiver can receive an email accompanying with a gift certificate although the email receiver is not a user who subscribes to email service using the SMS gift certificate 320 provided by the sender email server 210. As a result, the email receiver is not limited in users who subscribe to email service using a SMS gift certificate but includes subscribers of all email services that may receive emails.

When the email receiver uses the SMS gift certificate 320, the short message service server 230 checks a key value, an available period and an available number of usage on a basis of information on the gift certificate 320 transmitted from the sender email server 210, and transmits a short message to the mobile terminal 240 corresponding to the connected line number number.

Here, the short message service server 130 transmits a short message as it is if a connected line number is one of a mobile terminal. However, if the connected line number is a wired phone number of the terminal having a screen display device, the short message service server 130 transmits the short message. Otherwise, the content of the short message that is converted into sound is transmitted.

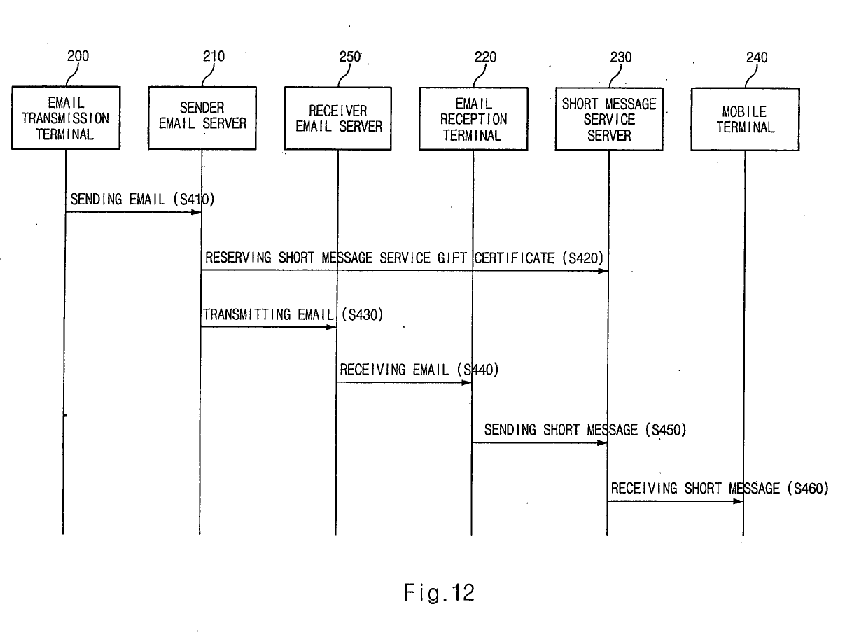

FIG. 12 is a flow chart illustrating a method for providing email service by configuration of FIG. 9 according to the second embodiment of the present invention.

An email sender writes an email through the email transmission terminal 200, purchases a SMS gift certificate, attaches the gift certificate to the written email and transmits the email to the sender email server 210 (S410).

Here, the email sender may previously set the available period, a connected line number, a calling line number and the content of the email in the SMS gift certificate or may enable a receiver to set the above conditions.

The sender email server 210 that receives the email accompanying with the SMS gift certificate generates an administration key, and transmits information of the gift certificate set by the email sender to the short message service server 230 so that the usage of the short message service may be reserved (S420).

The sender email server 210 transmits the email accompanying with the SMS gift certificate transmitted to the receiver email server 250 by the email sender (S430).

The email receiver connects to the receiver email server 250 with the email reception terminal 220 and confirms the email (S440). Here, if the SMS gift certificate is attached to the email, the email receiver writes a short message and transmits the message (S450).

When the email receiver writes the short message using the SMS gift certificate attached to the email, the email receiver writes the message according to a method set by the email sender. If the email sender does not set a specific method, the email receiver may use the gift certificate according to an object of usage.

If the short message that the email receiver writes using the SMS gift certificate is transmitted to the short message service server 230, the short message service server 230 determines the availability with the administration key value.

If the determination result on the availability is a request on the reserved short message service, the short message service server 230 transmits the short message to the designated mobile terminal 240 (S460).

Here, the short message that the email receiver writes using the SMS gift certificate is transmitted not from the receiver email server 250 but from the email reception terminal 220 to the short message service server 230 through the Internet.

### INDUSTRIAL APPLICABILITY

As discussed earlier, according to the present invention, since a service provider directly provides a value-added service to an internet user using an internet message transfer medium, the user can receive directly the value-added service without connecting to a Web site. As a result, a business person who provides the value-added service can improve profitability not with a passive method for providing service when an internet user connects to a web site but with an active method for directly providing service to an internet user.

According to the present invention, since an advertiser sends advertisings email accompanying with value-added service usage tickets, the advertiser need not send a large quantity of advertising emails to a large number of internet users without permission in order to improve the effect of advertisement. Instead, the advertiser sends advertising emails to internet users who permits reception of the advertising emails, thereby effectively advertising with less cost. Additionally, since advertising emails according to the present invention are transmitted from one to another for usage of value-added service usage tickets, the advertising emails may be rapidly distributed to internet users, thereby increasing the effect of advertisement. Through this transmission effect, the advertising emails accompanying with value-added service usage tickets may be employed as customer obtaining means which actively advertise products and service of business.

In addition, since SMS gift certificates attached to emails are sent only when an email sender wants a reply, a user can receive the email reply with a short message. As a result, the user need not connect to a web site which provides email service for confirmation of email reception, thereby providing convenience to the email service users.

1. A system for providing internet value-added service, comprising:
a first message transfer server for providing service to transmit a message transfer medium in Internet, for providing a value-added service usage ticket attached to the message transfer medium to a value-added service provider, for administering information of the service provider and the value-added service usage ticket, and for transmitting the message transfer medium accompanying with the value-added service usage ticket if the service provider transmits the value-added service usage ticket attached to the message transfer medium;
a second message transfer server for receiving the message transfer medium accompanying with the value-added service usage ticket which the service provider transmits to an internet user who logs in with a user terminal; and
a value-added service server for providing value-added service in the Internet, and for providing the value-added service to the user terminal by using the information of the service provider and the value-added service usage ticket transmitted from the first message transfer server if usage of the value-added service usage ticket is required from the internet user.

2. The system according to claim 1, wherein the second message transfer server transmits a message transfer medium accompanying with the value-added service usage ticket received from the first message transfer server to a different internet user by request of the internet user, and
the value-added service server provides the value-added service to a terminal of the different internet user if usage of the value-added service usage ticket is requested from the different internet user.

3. The system according to claim 1, wherein the service provider is an advertiser who transmits advertisement to the internet user with the message transfer medium, and the internet user permits reception of the advertisement from the advertiser.

4. The system according to claim 3, wherein the first message transfer server and the second message transfer server are email service servers, and the message transfer medium is an email.

5. The system according to claim 3, wherein the first message transfer server and the second message transfer server are MMS servers, and the message transfer medium is a multi-media message.

6. The system according to claim 3, wherein the first message transfer server and the second message transfer server are instant messenger service servers, and the message transfer medium is an instant messenger-type node.

7. The system according to claim 3, wherein the value-added service includes internet phone service, movie viewer service, VOD service, AOD service, SMS, internet cartoon service and internet game service.

8. The system according to claim 3, wherein information of the value-added service usage ticket includes an administration encoding key of the value-added service usage ticket, an available period of the value-added service usage ticket, kinds of the value-added service which can be used with the value-added service usage ticket, a price of the value-added service usage ticket and available number information of the value-added service usage ticket.

9. The system according to claim 8, wherein the value-added service server charges for the value-added service by using the value-added service usage ticket to the service provider through the first message transfer server.

10. The system according to claim 9, wherein the value-added service server administers the charge information including the administration encoding key of the value-added service usage ticket, an IP address of the internet user by using the value-added service usage ticket, date when the value-added service usage ticket is used and usage time.

11. The system according to claim 1, wherein the first message transfer server and the second message transfer server are email servers, and the value-added service server is a SMS server.

12. The system according to claim 1, wherein the internet user transmits a short message as an reply on the message transfer medium received from the service provider by using the value-added service usage ticket.

13. The system according to claim 12, wherein information of the value-added service usage ticket includes an administration encoding key of the value-added service usage ticket, an available period of the value-added service usage ticket, calling line number and connected line number of the short message, content of the short message and available number information of the value-added service usage ticket.

14. The system according to claim 13, wherein the calling line number and the connected line number of the short message, and the content of the short message are set by the internet user using the value-added service usage ticket.

15. The system according to claim 14, wherein the value-added service server converts the content of the short message into sound when the calling line number of the short message is a number of a wired terminal, and the wired terminal does not comprise a screen display device.

16. A method for providing internet value-added service, comprising:
a first process for setting the value-added service usage ticket information in an internet message transfer server if an internet value-added service provider purchases the value-added service usage ticket on the value-added service to be provided;
a second process for providing information of the set value-added service usage ticket to a value-added service server for providing the value-added service in the internet message transfer server;
a third process for transmitting the set value-added service usage ticket attached to a message transfer medium in the internet message transfer server if the value-added service provider requires transmission of the message transfer medium accompanying with the value-added service usage ticket; and
a fourth process for providing the value-added service in the value-added service server contracted on the value-added service usage ticket with the internet message transfer server if an internet user receiving the message transfer medium accompanying with the value-added service usage ticket requires usage of the value-added service usage ticket.

17. The method according to claim 16, further comprising:
a fifth process, in an internet message transfer server of an internet user received the message transfer medium accompanied with the value-added service usage ticket, for transmitting the message transfer medium accompanied with the value-added service usage ticket received to a different internet user;
a sixth process for providing the value-added service in the value-added service server if the different internet user requires usage of the value-added service usage ticket.

18. The method according to claim 16, wherein a person who transmits the message transfer medium accompanied with the value-added service usage ticket is an advertiser, and the advertiser transmits advertisement accompanying with the value-added service usage ticket by using the message transfer medium.

19. The method according to claim 18, wherein the internet message transfer server is an email service server, and the message transfer medium is an email.

20. The method according to claim 18, wherein the internet message transfer server is a MMS server, and the message transfer medium is a multimedia message.

21. The method according to claim 18, wherein the internet message transfer server is an instant messenger service server, and the message transfer medium is an instant messenger type note.

22. The method according to claim 18, wherein the value-added service includes internet phone service, movie viewer service, VOD service, AOD service, SMS, internet cartoon service and internet game service.

23. The method according to claim 18, wherein information of the value-added service usage ticket includes an administration encoding key of the value-added service usage ticket, an available period of the value-added service usage ticket, kinds of the value-added service which can be used with the value-added service usage ticket, a price of the value-added service usage ticket and available number information of the value-added service usage ticket.

24. The method according to claim 23, wherein the value-added service server charges for the value-added service using the value-added service usage ticket to the service provider through the first message transfer server.

25. The method according to claim 23, wherein the value-added service server administrates the charge information including the administration encoding key of the value-added service usage ticket, an IP address of the internet user using the value-added service usage ticket, date when the value-added service usage ticket is used and usage time.

26. The method according to claim 16, wherein the internet message transfer server is an email server, and the value-added service server is a SMS server.

27. The method according to claim 16, wherein the internet user transmits a short message as a reply of a message transfer medium received from the service provider by using the value-added service usage ticket.

28. The method according to claim 27, wherein information of the value-added service usage ticket includes an administration encoding key of the value-added service usage ticket, an available period of the value-added service usage ticket, calling line number and connected line number of the short message, content of the short message and available number information of the value-added service usage ticket.

29. The method according to claim 28, wherein the calling line number and the connected line number of the short message, and the content of the short message are set by the internet user using the value-added service usage ticket.

30. The method according to claim 29, wherein the value-added service server converts the content of the short message into sound when the calling line number of the short message is a number of a wired terminal, and the wired terminal does not comprise a screen display device.
